(19) United States
(12) Patent Application Publication
(10) Pub. No.: US 2005/0138543 A1
(43) Pub. Date: Jun. 23, 2005

(54) Computer-based training system and method providing multiple format specific media files

(75) Inventor: Joanna Liu, Hsinchu City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/742,373

(22) Filed: Dec. 18, 2003

(51) Int. Cl. G06F 17/00

(52) U.S. Cl. 715/513; 715/500.1

(57) ABSTRACT

A multi-site training system and a multi-site training method employ an authoring tool. The authoring tool: (1) receives source materials for a training module; (2) generates a plurality of media files from the source materials in a plurality of formats; and (3) generates at least one HTML page identifying the plurality of media files in the plurality of formats. The plurality of media files is installed in at least one media server and the at least one HTML page is installed in at least one information server. The plurality of media files in the plurality of formats provides the system and method with enhanced efficiency.

### BACKGROUND OF THE INVENTION

1. Field of the Invention

The invention relates generally to computer-based training systems. More particularly, the invention relates to computer based training systems with enhanced performance.

2. Description of the Related Art

Computer-based training and education systems offer several advantages over traditional classroom and instructor based-systems. Computer-based systems are generally cost-effective, and they often allow individual students to progress through course curricula at individual rates. With continuing advances in computer and information technology, computer-based systems also provide an opportunity to efficiently reach increased numbers of students at multiple geographically dispersed training and education sites.

While multi-site and multi-user computer based systems are particularly desirable, they are nonetheless not entirely without problems. Efficiency of multi-site systems is often compromised due to incompatibilities of hardware and software between a central site that authors and produces a training module and: (1) a plurality of remote training module rebroadcast sites, or (2) a remote user that might otherwise desire to access a training module.

The invention is thus directed towards providing multi-site computer-based training and education systems with enhanced efficiency.

### SUMMARY OF THE INVENTION

A first object of the invention is to provide a multi-site computer based training system and method.

A second object of the invention is to provide a system and method in accord with the first object of the invention, where the system and method are efficient.

In accord with the objects of the invention, the invention provides: (1) an authoring tool employed for authoring training modules; (2) a multi-site computer based training system predicated thereupon; and (3) a method for operating the multi-site system.

In accord with the invention, the authoring tool comprises a tangible medium having incorporated therein machine readable instructions. The machine readable instructions provide for: (1) receiving source materials for a training module; (2) generating a plurality of media files from the source materials in a plurality of formats; and (3) generating at least one HTML page identifying the plurality of media files in the plurality of formats.

The authoring tool in accord with the invention contemplates the system in accord with the invention and the method in accord with the invention.

The invention provides an efficient multi-site computer based training system and method.

The invention realizes the foregoing object by employing a specific authoring tool within the multi-site computer based training system and method. The authoring tool: (1) receives source materials for a training module; (2) generates a plurality of media files from the source materials in a plurality of formats; and (3) generates at least one HTML page identifying the plurality of media files in the plurality of formats. After installing the plurality of media files in at least one media server and the at least one HTML page in at least one information server, a training module user may select a specific training module format on the at least one HTML page in accord with the user's needs. The training module in the requested format (or access thereto) is or will be provided to the user. Due to the production of the plurality of media files in the plurality of formats, an enhanced probability of production of a media file for a specific user's needs exists. Thus, the invention provides a multi-user computer-based training system and method with enhanced efficiency.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic diagram of a multi-user computer-based training system in accord with the invention.

FIG. 2 shows a schematic diagram of a training module development process not in accord with the invention.

FIG. 3 shows a schematic diagram of a training module development process in accord with the invention.

FIG. 4 shows a schematic diagram illustrating operation of an authoring tool in accord with the invention.

FIG. 5 shows several lines of computer code that may be employed for selecting a training module based upon a user's display screen resolution.

### DESCRIPTION OF THE PREFERRED EMBODIMENT

The invention provides an efficient multi-site computer based training system and method.

The invention realizes the foregoing object by employing a specific authoring tool within the multi-site computer based training system and method. The authoring tool: (1) receives source materials for a training module; (2) generates a plurality of media files from the source materials in a plurality of formats; and (3) generates at least one HTML page identifying the plurality of media files in the plurality of formats. After installing the plurality of media files in at least one media server and the at least one HTML page in at least one information server, a training module user may select a specific training module format on the at least one HTML page in accord with the user's needs. The training module in the requested format (or access thereto) is or will be provided to the user. Due to the production of the plurality of media files in the plurality of formats, an enhanced probability of production of a media file for a specific user's needs exists. Thus, the invention provides a multi-user computer-based training system and method with enhanced efficiency.

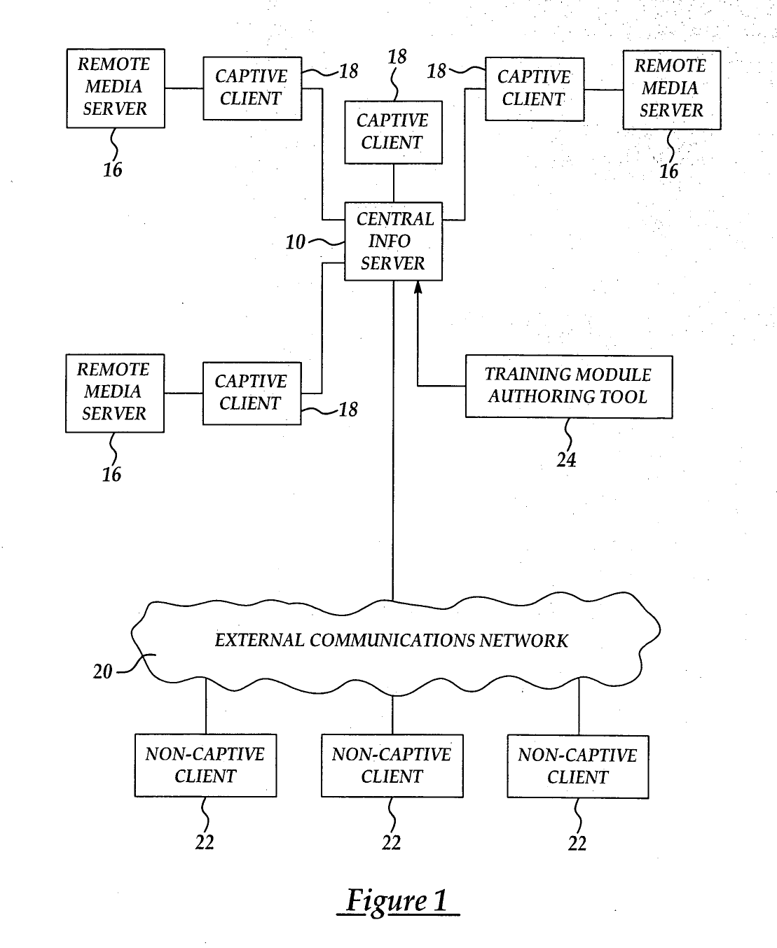

FIG. 1 shows a schematic diagram of a multi-site computer based training system in accord with the invention.

The multi-site system comprises a central information server 10. Several remote media servers 16 are connected to the central information server 10 through a series of captive clients 18. Depending upon the size of the entity that they service, the foregoing servers may be provided as mini mid-range, or mainframe servers. The remote media servers 16 are intended as computer systems that have capacity and ability to store media files that are employed within training modules. The central information server 10 is intended as serving a general information request and fulfillment portal within the multi-site computer system of FIG. 1. Each of the servers may operate any of several operating systems, including but not limited to Windows(™), UNIX(™), and Linux(™) operating systems.

The series of captive clients 18 is intended as users also generally conventional in the art. They may comprise simple terminal user interfaces. Alternatively, they may also comprise computer systems, such as mini computer systems, micro computer systems or personal computer systems with separate additional functionality and capacity.

The central information server 10 is also connected to an external communications network 20. A series of non-captive clients 22 is also connected to the external communications network 20.

The external communications network 20 is generally a distributed communications network, such as an Internet distributed communications network. The external communications network 20 may also comprise other communications networks, such as but not limited to intranet, wide area network (WAN) and local area network (LAN) communications networks.

The series of non-captive clients 22 is intended as generally analogous to the series of captive clients 18. They may employ analogous hardware and software user interface components, but they are not associated with any specific information server and may be operated by independent users or customers of a business entity that owns and maintains the central information server 10.

Finally, a training module authoring tool 24 is associated the central information server 10. The training module authoring tool 24, and its method of operation within the context of the multi-site computer system of FIG. 1, comprise in part the invention. While FIG. 1 illustrates the training module authoring tool 24 as associated with the central information server 10, the invention also contemplates that the training module authoring tool 24 may also be associated with one of the remote media servers 16. The selection of location, or locations, of the training module authoring tool 24 is generally arbitrary within the context of resource and staffing requirements of a business entity.

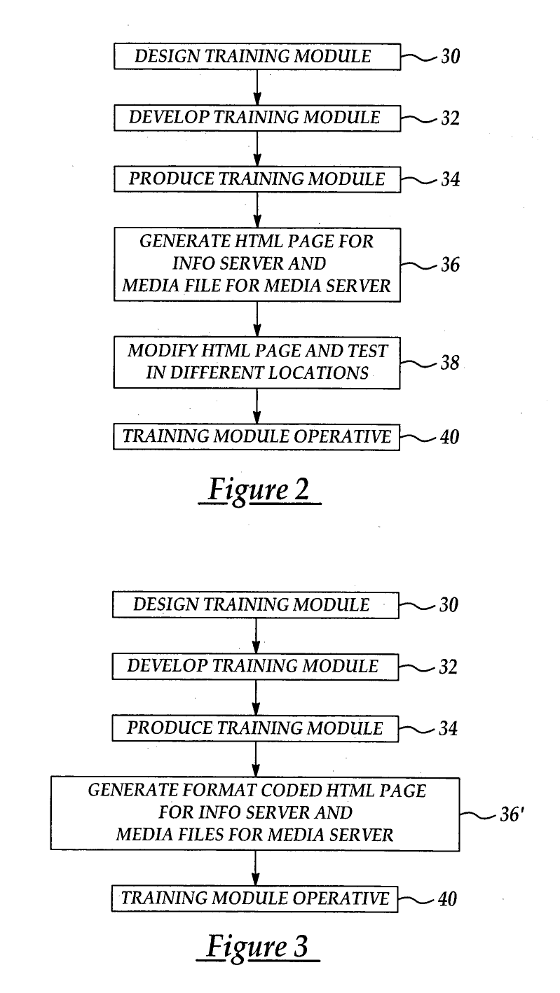

To better understand the invention, FIG. 2 shows a schematic diagram illustrating a series of process steps in accord with developing a training module not in accord with the invention.

In accord with reference numeral 30, a training module is first designed. Generally, a training analyst evaluates a need and content for a specific training module. The need may be an internal need (i.e., for training employees of a business entity) or in the alternative the need may be an external need (i.e., for training customers or clients of the business entity). Independent of the nature of the need, the training analyst defines the basic features of a training module. The basic features may include, but are not limited to scope of subject matter included, training module presentation length and sophistication of intended audience.

In accord with reference numeral 32, the training module is developed from its original design. The development phase will generally include preparation of demonstration exhibits, and the selection and scripting of instructors as presenters within the training module.

In accord with reference numeral 34, the training module is produced. The production generally involves recording of a video component and an audio component of an instructor's presentation, in conjunction with demonstration of demonstration exhibits. A result of the production is a set of recorded tangible audio and video media (i.e., disk, tape or other memory device) for the training module.

In accord with reference numeral 36, a media file is generated from the recorded media produced for the training module. The media file is installed and stored on a media server (such as media server 16 as illustrated in FIG. 1). In addition, an HTML (hypertext mark-up language) page is generated referencing the training module. The HTML page is installed, stored and catalogued on an information server (such as information server 10 as illustrated in FIG. 1).

In accord with reference numeral 38, the HTML page (and perhaps also the media file) is tested and modified in different sites where the training module is intended to be used or broadcast, such as to assure that it operates properly within the hardware and software constraints of those locations.

In accord with reference numeral 40, the training module is deemed operative and its use by users is permitted.

Although the training module production and qualification scheme as illustrated in FIG. 2 is generally common, it is nonetheless not entirely without problems.

In particular, the testing and modification of the HTML page and media file for proper use in different sites (i.e., the debugging of the training module with respect to use in different sites) is often time consuming and inefficient. An HTML page or media files often need to be modified such as to provide for proper fit to a user interface screen or for other appropriate compatibility with user site hardware or software.

The present invention is thus directed towards more efficiently producing training modules. The training module authoring tool 24 of FIG. 1 assists in that goal. To that end, the present invention provides a training module production sequence in accord with FIG. 3.

The training module production and qualification process steps illustrated in FIG. 3 correspond generally with the process steps as illustrated in FIG. 2, with the exception of: (1) deletion of the HTML page (and optional media file) testing and modification in various locations (step corresponding with reference numeral 38); and (2) a revision of the step corresponding with reference numeral 36 to provide a process step designated as 36′. The process step corresponding with reference numeral 36′ provides for: (1) generating at least one format coded HTML page for at least one information server; and (2) generating (generally multiple formatted) media files for at least one media server.

Within the invention, the training module authoring tool 24 generally creates multiple format media files for different expected client user hardware and software formats. The formats may be directed towards at least user screen size and resolution, audio software capabilities or video software capabilities. The training module authoring tool 24 also generates at least one HTML page format coded for the various format options of the plurality of format coded media files. Thus, in accord with the invention, a user when requesting a training module will encounter a selection of available options for formats such as audio file type, video file type and screen resolution that the user may select consistent with the user's available hardware and software resources for viewing the training module. The invention contemplates that the various formatted media files may be tested in conjunction with the information server and media server on which they are installed (and they may be installed on various media servers), but further additional testing and debugging at remote locations is neither anticipated nor contemplated. The invention also contemplates that the training module authoring tool 24 is a software tool with machine readable instructions encoded into a tangible medium.

Within the invention, the library of multiply formatted media files for a specific training module may be stored on a single media server or on separate media servers. Typically, they will be stored on separate media servers. Under circumstances where the library of multiply formatted media files is stored on separate media servers, the invention also contemplates that a format coded HTML page that catalogues the library of multiply formatted media files may comprise, or serve, as a active server page (ASP). The active server page provides for a redirection of a user when requesting a media file in a particular format to the media server where the media file in the particular format is stored or resident. Thus, a user when accessing a particular link on the HTML page that corresponds with a media file in a specific desired format (i.e., typically by mouse clicking on the link) will be automatically directed to the media server where the media file in the specific desired format is stored or resident.

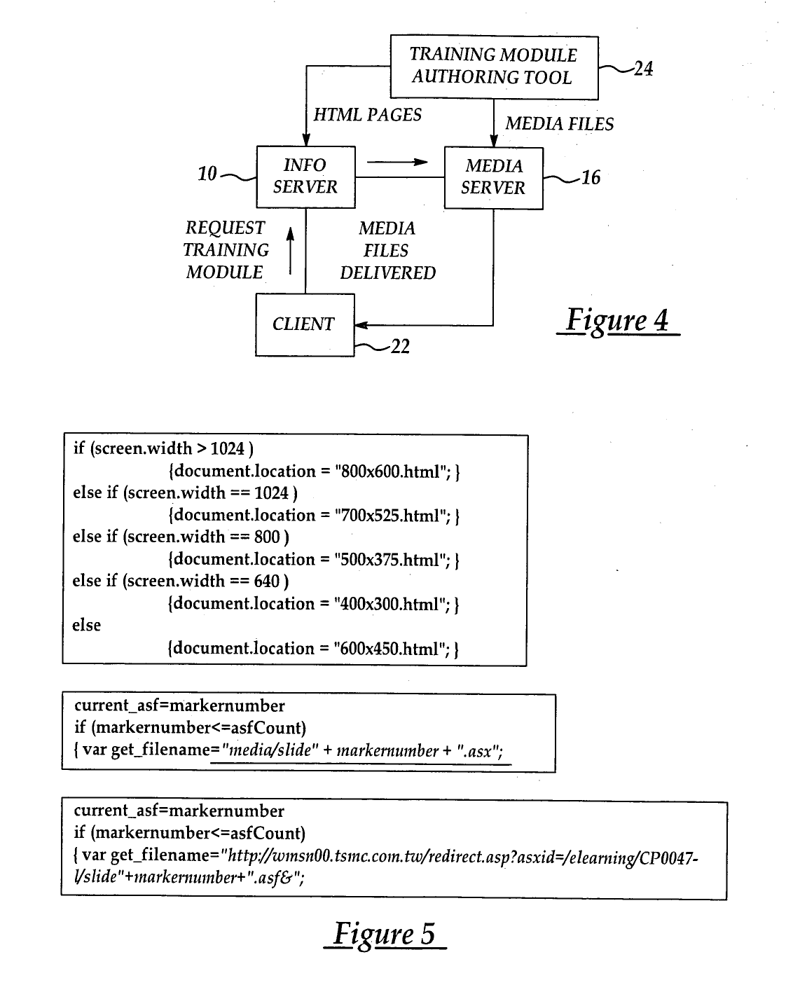

FIG. 4 shows a schematic diagram of operation of the training module authoring tool 24 of the invention.

The training module authoring tool 24 provides a plurality of multiply formatted media files to the media server 16, as well as at least one format coded HTML page to the information server 10. A client 22 requests a training module through connection with the information server 10 and selects a media file in a particular format. The media file in the particular format is provided from the media server 16 and delivered (i.e., downloaded) to the client 22 where it may be viewed. Alternatively, and in accord with the disclosure above, a user may be directed or redirected through an HTML active server page to a media server where the desired media file is resident or stored. The user may view the media file as resident or stored at that site, without necessarily a need for downloading the media file.

As an example of the invention, FIG. 5 illustrates several lines of computer code directed towards media files formatted for display screens of varying resolution. The computer code indicates HTML coding correspondence and location of media files, as well as instructions for redirect of a request to specific locations to access the media files.

The preferred embodiment of the invention is illustrative of the invention rather than limiting of the invention. Revisions and modifications may be made to components in accord with the preferred embodiment, while still providing a system and a method in accord with the invention, further in accord with the accompanying claims.

1. An authoring tool comprising:
a tangible medium having incorporated therein machine readable instructions, the machine readable instructions providing for:
receiving source materials for a training module;
generating a plurality of media files from the source materials in a plurality of formats; and
generating at least one HTML page identifying the plurality of media files in the plurality of formats.

2. The authoring tool of claim 1 wherein the source materials are provided as recorded tangible video media and recorded tangible audio media.

3. The authoring tool of claim 1 wherein the plurality of formats comprises a plurality of user display screen resolutions.

4. The authoring tool of claim 1 wherein the plurality of formats comprises a plurality of audio software formats.

5. The authoring tool of claim 1 wherein the plurality of formats comprises a plurality of video software formats.

6. The authoring tool of claim 1 wherein the HTML page also serves as an active server page for purposes of redirecting a requester of a media file in a specific format to a media server where the media file in the specific format is resident.

7. A multi-site training system comprising:
at least one information server;
a plurality of media servers connected to the at least one information server; and
an authoring tool associated with the at least one information server and at least one media server, where the authoring tool provides for:
receiving source materials for a training module;
generating a plurality of media files from the source materials in a plurality of formats; and
generating at least one HTML page identifying the plurality of media files in the plurality of formats.

8. The system of claim 7 wherein the authoring tool further provides for:
installing the plurality of media files in the at least one media server; and
installing the at least one HTML page in the at least one information server.

9. The system of claim 7 wherein the source materials are provided as recorded tangible video media and recorded tangible audio media.

10. The system of claim 7 wherein the plurality of formats comprises a plurality of display screen resolutions.

11. The system of claim 7 wherein the plurality of formats comprises a plurality of audio software formats.

12. The system of claim 7 wherein the plurality of formats comprises a plurality of video software formats.

13. The system of claim 7 further comprising a client user connected to the at least one information server.

14. The system of claim 13 wherein the client user is a captive client user.

15. The system of claim 7 wherein the HTML page also serves as an active server page for purposes of redirecting a requester of a media file in a specific format to a media server where the media file in the specific format is resident.

16. A method for producing a training module comprising:
providing an authoring tool associated with at least one information server and at least one media server, where the authoring tool provides for:
receiving source materials for a training module;
generating a plurality of media files from the source materials in a plurality of formats; and
generating at least one HTML page identifying the plurality of media files in the plurality of formats;
providing the source materials to the authoring tool;
generating the plurality of media files from the source materials in the plurality of formats and installing the plurality of media files in the at least one media server; and
generating the at least one HTML page from the source materials and installing the at least one HTML page in the at least one information server.

17. The method of claim 16 wherein the source materials are provided as recorded tangible video media and recorded tangible audio media.

18. The method of claim 16 wherein the plurality of formats comprises a plurality of display screen resolutions.

19. The method of claim 16 wherein the plurality of formats comprises a plurality of audio software formats.

20. The method of claim 16 wherein the plurality of formats comprises a plurality of video software formats.

21. The method tool of claim 16 wherein the HTML page also serves as an active server page for purposes of redirecting a requester of a media file in a specific format to a media server where the media file in the specific format is resident.

22. A method for operating a multi-site training system comprising:
providing a multi-site training system comprising:
at least one information server;
a plurality of media servers connected to the at least one information servers;
at least one client user connected to at least one of the at least one information server and the plurality of media servers; and
an authoring tool associated with the at least one information server and at least one media server, where the authoring tool provides for:
receiving source materials for a training module;
generating a plurality of media files from the source materials in a plurality of formats; and
generating at least one HTML page identifying the plurality of media files in the plurality of formats;
providing the source materials to the authoring tool;
generating the plurality of media files from the source materials in the plurality of formats and installing the plurality of media files in the at least one media server;
generating the at least one HTML page from the source materials and installing the at least one HTML page in the at least one information server; and
providing client user access to the at least one HTML page, selection of a media file in a specific format and access to the media file in the specific format.

23. The method of claim 22 wherein the source materials are provided as recorded tangible video media and recorded tangible audio media.

24. The method of claim 22 wherein the plurality of formats comprises a plurality of display screen resolutions.

25. The method of claim 22 wherein the plurality of formats comprises a plurality of audio software formats.

26. The method of claim 22 wherein the plurality of formats comprises a plurality of video software formats.

27. The method of claim 22 wherein the HTML page also serves as an active server page for purposes of redirecting a requester of a media file in a specific format to a media server where the media file in the specific format is resident.
